(19) United States
(12) Patent Application Publication
(10) Pub. No.: US 2013/0154965 A1
(43) Pub. Date: Jun. 20, 2013

(54) TOUCH DETECTION SYSTEM AND DRIVING METHOD THEREOF

(71) Applicants: Hee-Chul Hwang, Yongin-city (KR); Dong-Won Lee, Yongin-city (KR); Joo-Hyung Lee, Yongin-city (KR)

(72) Inventors: Hee-Chul Hwang, Yongin-city (KR); Dong-Won Lee, Yongin-city (KR); Joo-Hyung Lee, Yongin-city (KR)

(21) Appl. No.: 13/572,575

(22) Filed: Aug. 10, 2012

(30) Foreign Application Priority Data
Dec. 20, 2011 (KR) 10-2011-0138139

(51) Int. Cl. G06F 3/041

(52) U.S. Cl. 345/173

(57) ABSTRACT

A touch sensing system for detecting at least one touch is provided. The touch sensing system includes a touch sensing unit having a plurality of touchable regions for outputting sensing signals of the at least one touch, an operating unit for determining difference values between the sensing signals and a baseline value, a group setting unit for grouping ones of the regions in which the difference values exist into one or more groups, and a threshold value determining unit for determining maximum difference values from the groups to determine first threshold values of the groups corresponding to the determined maximum difference values. The touch sensing system increases the correctness of the touch detection by adaptively changing the first threshold value in accordance with the touch strength. A method of driving the touch sensing system is also provided.

### CROSS-REFERENCE TO RELATED APPLICATION

This application claims priority to and the benefit of Korean Patent Application No. 10-2011-0138139, filed on Dec. 20, 2011, in the Korean Intellectual Property Office, the entire content of which is incorporated herein by reference.

### BACKGROUND

1. Field

Aspects of embodiments of the present invention relate to a touch sensing system and a method of driving the same.

2. Description of the Related Art

A touch screen of an image display device is an input device capable of inputting the command of a user by having a human hand or object touch the screen, thereby selecting the corresponding content displayed on the screen. As such, the touch screen is provided on the front face of the image display device to convert a contact position of the human hand or the object into an electrical signal. The corresponding instruction content selected in the contact position is then received as an input signal. Since the touch screen is capable of replacing another input device coupled to the image display device, such as a keyboard or a mouse, the range of uses for the touch screen is gradually increasing.

Methods of realizing a touch screen include a resistance layer method, a photo-sensing method, and a capacitance method. In the capacitance method, a change in capacitance generated when the human hand or the object contacts the touch screen is detected to identify the touch position. As such, a touch sensing system for sensing the coordinates of the touch position by analyzing the sensing signals output from a plurality of sensor electrodes is provided. That is, the touch sensing system determines that the touch of the user exists when a difference between the sensing signals and a baseline value is larger than a predetermined threshold value.

When the user does not input anything with a finger and there is no influence of external noise, the value sensed by the touch screen is uniform. This uniform value is referred to as the baseline. That is, the baseline is a basic input value when there is no input to the touch screen. Noise refers to unintended touch signals being generated by the system due to a variety of reasons, such as mechanical. The threshold value is chosen in part to distinguish between noise and intended touch signals.

In conventional touch screen products, the threshold value is determined before the products are shipped. In addition, the value remains fixed after the products are shipped. However, when using such a fixed threshold value, the touch strength may vary in accordance with a user or a touch tool (for example, a finger or a stylus), such that the correctness of the touch detection varies between users or touch tools.

In particular, when an object having a large touch strength and an object having a small touch strength touch the touch screen at the same time, the value of the threshold value can determine which of these touches are detected. For instance, when a low threshold value is used to detect the two kinds of touch, the sensitivity of the touch screen may increase too much, such that the influence of noise becomes large. On the other hand, when a high threshold value is used to detect the two kinds of touch, the touch of the object having a small touch strength may not be sensed.

### SUMMARY

Aspects of embodiments of the present invention relate to a touch sensing system and a method of driving the same. In particular, aspects of embodiments of the present invention relate to a touch sensing system and a method of driving the same that are capable of improving the correctness of touch detection by adaptively changing a first threshold value of touch detection in accordance with the touch strength.

According to an exemplary embodiment of the present invention, a touch sensing system for detecting at least one touch is provided. The touch sensing system includes a touch sensing unit including a plurality of touchable regions for outputting sensing signals of the at least one touch, an operating unit for determining difference values between the sensing signals and a baseline value, a group setting unit for grouping ones of the regions in which the difference values exist into one or more groups, and a threshold value determining unit for determining maximum difference values from the groups to determine first threshold values of the groups corresponding to the determined maximum difference values.

The touch sensing system may further include a touch determining unit for determining touched regions from the ones of the regions whose difference values are larger than their corresponding first threshold values.

The touched regions may correspond to the at least one touch.

The group setting unit may be configured to group adjacent regions from the ones of the regions into a same group.

The threshold value determining unit may be configured to multiply a first ratio by the determined maximum difference values to calculate the first threshold values of the groups.

The first ratio may be set to a value between 0 and 1.

The touch sensing unit may include first sensor electrodes and second sensor electrodes that cross each other to implement a capacitance method of touch sensing.

The difference values may exist when they exceed a second threshold value.

The difference values may exist when they are not 0.

The touch sensing unit may be a touch screen.

According to another exemplary embodiment of the present invention, a method of driving a touch sensing system for detecting at least one touch is provided. The method includes outputting sensing signals of the at least one touch from a plurality of touchable regions of a touch sensing unit, determining difference values between the sensing signals and a baseline value, grouping ones of the regions in which the difference values exist into one or more groups, and determining maximum difference values from the groups to determine first threshold values of the groups corresponding to the determined maximum difference values.

The method may further include determining touched regions from the ones of the regions whose difference values are larger than their corresponding first threshold values.

The touched regions may correspond to the at least one touch.

The grouping the ones of the regions may include grouping adjacent regions from the ones of the regions into a same group.

The determining the maximum difference values from the groups to determine the first threshold values of the groups corresponding to the determined maximum difference values may include multiplying a first ratio by the determined maximum difference values to calculate the first threshold values of the groups.

The first ratio may be set to a value between 0 and 1.

The touch sensing unit may include first sensor electrodes and second sensor electrodes that cross each other to implement a capacitance method of touch sensing.

The difference values may exist when they exceed a second threshold value.

The difference values may exist when they are not 0.

The touch sensing unit may be a touch screen.

As described above, according to aspects of embodiments of the present invention, it is possible to provide a touch sensing system and a method of driving the same that increase the correctness of the touch detection by adaptively changing the first threshold value of touch detection in accordance with the touch strength.

### BRIEF DESCRIPTION OF THE DRAWINGS

The accompanying drawings, together with the specification, illustrate exemplary embodiments of the present invention, and, together with the description, serve to explain aspects and principles of the present invention.

FIG. 1 is a block diagram illustrating a touch sensing system according to an embodiment of the present invention;

FIG. 2 is a view illustrating an embodiment of the touch sensing unit illustrated in FIG. 1;

FIG. 3 is a view illustrating difference values determined for the regions of the touch sensing unit by an operating unit according to an embodiment of the present invention;

FIG. 4 is a view illustrating a grouping operation of a group setting unit according to an embodiment of the present invention;

FIG. 5 is a view illustrating regions determined to be touched regions by a touch determining unit according to an embodiment of the present invention; and

FIG. 6 is a flowchart illustrating a method of driving a touch sensing system according to an embodiment of the present invention.

### DETAILED DESCRIPTION

Hereinafter, certain exemplary embodiments of a touch sensing and a method of driving the same according to the present invention will be described with reference to the accompanying drawings. Here, when a first element is described as being coupled to a second element, the first element may be directly coupled to the second element or indirectly coupled to the second element via one or more third elements. Further, some of the elements that are not essential to the complete understanding of the invention are omitted for clarity. In addition, like reference numerals refer to like elements throughout. Moreover, it should be noted that the present invention may be embodied in many different forms and should not be construed as being limited to the embodiments set forth herein.

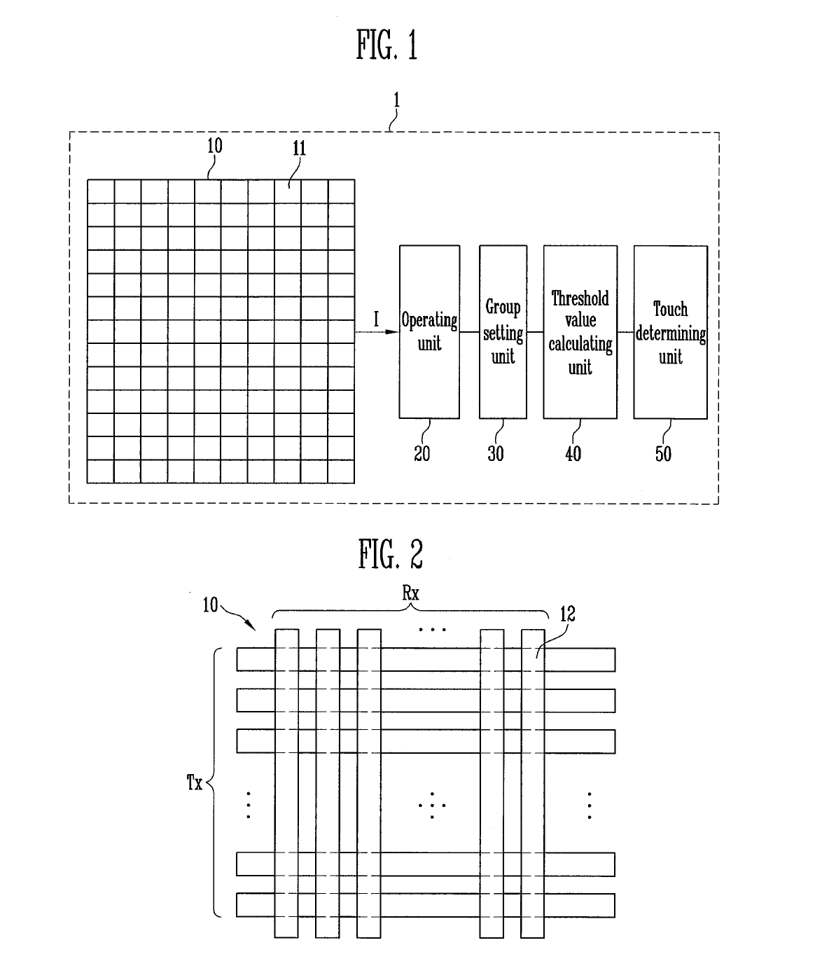

FIG. 1 is a block diagram illustrating a touch sensing system 1 according to an embodiment of the present invention.

Referring to FIG. 1, the touch sensing system 1 includes a touch sensing unit 10 (such as a touch screen), an operating unit 20, a group setting unit 30, a threshold value calculating unit (or threshold value determining unit) 40 for determining a first threshold value, and a touch determining unit 50. The touch sensing system 1 may be, for example, part of a touch-sensitive device, such as an image display device. Parts of the touch sensing system 1 may be implemented in hardware, while other parts may be implemented in software or firmware designed to operate in conjunction with a processing unit (e.g., a microprocessor). To this extent, different components of the touch sensing system 1, such as the operating unit 20, the group setting unit 30, the threshold value calculating unit 40, or the touch determining unit 50 may share the same processing unit.

The touch sensing unit 10 is a touch sensor that uses a capacitance method for detecting touch. The touch sensing unit 10 includes a plurality of sensor electrodes in order to sense the touch of a user (for example, the strength or location of a touch on an input device such as a touch screen). The touch sensing unit further includes a plurality of touchable regions 11 corresponding to coordinates (for example, predetermined coordinates).

In addition, the touch sensing unit 10 outputs sensing signals I from the sensor electrodes. The sensing signals I have values (for example, predetermined values) representing, for example, changes in capacitance formed in the corresponding regions. The touch sensing system 1 analyzes the sensing signals I to determine whether the regions 11 are touched. The touch sensing unit 10 may be constituted, for example, in a mutual capacitance method or a self capacitance method.

FIG. 2 is a view illustrating an embodiment of the touch sensing unit 10 illustrated in FIG. 1.

Referring to FIG. 2, the touch sensing unit 10 includes first sensor electrodes Tx and second sensor electrodes Rx that cross each other. In addition, crossing regions 12 where the first sensor electrodes Tx and the second sensor electrodes Rx cross represent the corresponding coordinates of the plurality of touchable regions 11 set by the touch sensing unit 10.

The first sensor electrodes Tx and the second sensor electrodes Rx may be formed of a transparent conductive material such as indium tin oxide (ITO), indium zinc oxide (IZO), carbon nano tube (CNT), or graphene. In addition, the shape of the first sensor electrodes Tx and the second sensor electrodes Rx is not limited to the bar shape illustrated in FIG. 2, but may be other shapes in different embodiments (for example, diamond). The first sensor electrodes Tx and the second sensor electrodes Rx may, for example, be positioned in different layers, or may be positioned in the same layer through a bridge pattern.

The operating unit 20 determines (for example, calculates) difference values between a baseline value and the sensing signals output from the touch sensing unit 10 for the regions 11 set by the touch sensing unit 10. Since the sensing signals I are output from the corresponding regions 11 set by the touch sensing unit 10, the difference values are also calculated for the corresponding regions 11. The baseline is a value based on when there is no input (such as environmental noise or a touch) to the touch sensing unit 10 and may be determined (for example, calculated) from the sensing signals I detected when the touch sensing unit 10 is not touched. The operating unit 20 may be implemented, for example, in hardware or software (in conjunction with a computing processor).

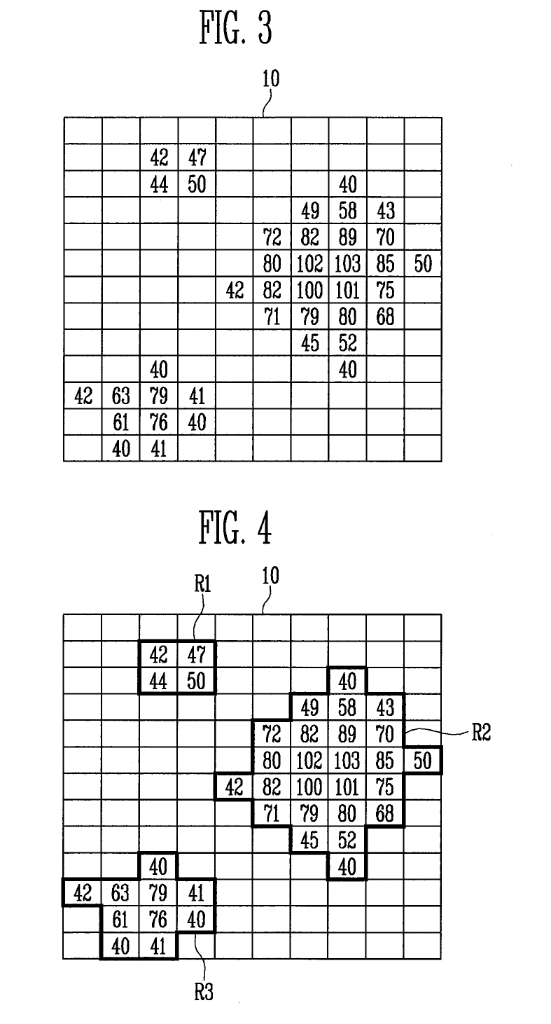

FIG. 3 is a view illustrating difference values determined for the regions 11 of the touch sensing unit 10 by the operating unit 20 according to an embodiment of the present invention. In the illustrated example of FIG. 3, three different touches are performed at similar times on the touch sensing unit 10. In addition, regions 11 in which the difference values do not exist (e.g., when the difference values between the sensing signals I and the baseline are 0, or when the difference values are less than a second threshold value, such as a predetermined threshold value) are represented as blanks and the regions 11 in which the difference values exist (e.g., when they are nonzero, or when they are greater than the second threshold value) are represented by the corresponding difference values. The existence or nonexistence of difference values thus reflects whether an input (such as noise or a touch) is sensed by (or intended to be sensed by) the touch sensing unit, and may be implemented by, for example, determining whether the difference values are nonzero, or determining if the difference values are larger than the second threshold value.

The group setting unit 30 groups the regions in which the difference values exist among the plurality of regions 11 set by the touch sensing unit 10 into at least one group, as illustrated in FIG. 4. This grouping may be based on such factors as contiguousness or difference values of the regions. The group setting unit 30 may be implemented, for example, in hardware or software (in conjunction with a computing processor, which may be shared with other components, such as the operating unit 20).

FIG. 4 is a view illustrating a grouping operation of the group setting unit 30 according to an embodiment of the present invention.

Referring to FIG. 4, the group setting unit 30 may, for example, divide the regions illustrated in FIG. 3, in which the difference values exist, into a first group R1, a second group R2, and a third group R3. In order to distinguish the groups from each other, the group setting unit 30 may provide IDs (for example, predetermined IDs) to the respective groups. The first group R1, for example, may illustrate a region touched by a small stylus. The second group R2 may illustrate a region strongly touched by a finger. The third group R3 may illustrate a region quickly touched by a finger.

The group setting unit 30, for example, may group adjacent regions 11 among the regions in which the difference values exist into the same group to generate at least one group. Therefore, as shown in FIG. 4, four regions 11 adjacent to each other and having the difference values of 42, 47, 44, and 50 are grouped into the first group R1. In addition, ten regions adjacent to each other and having the difference values of 40, 42, 63, 79, 41, 61, 76, 40, 40, and 41 are grouped into the second group R2. Finally, 25 regions adjacent to each other and having the difference values of 40, 49, 58, 43, 72, 82, 89, 70, 80, 102, 103, 85, 50, 42, 82, 100, 101, 75, 71, 79, 80, 68, 45, 52, and 40 are grouped into the third group R3. That is, the regions that belong to the first group R1, the second group R2, and the third group R3 are not adjacent to the regions that belong to another group.

As illustrated in FIG. 4, since the difference values of the respective groups are significantly different from each other, when a fixed threshold value is applied, it may be difficult to correctly detect touch. For example, when the fixed threshold value is set to be 60, since the difference values that the regions belonging to the first group R1 have are smaller than 60, they are not recognized as a touch, even though they represent a touch by a stylus.

In order to solve or lessen the occurrence of such a problem, the threshold value calculating unit 40 determines the maximum difference values from the groups and determines (e.g., calculates) first threshold values corresponding to the detected maximum difference values from each of the groups. For example, when the case illustrated in FIG. 4 is considered, the value 50 is chosen from the first group R1 since the maximum difference value of the first group R1 is 50, the value 103 is chosen from the second group R2 since the maximum difference value of the second group R2 is 103, and the value 79 is chosen from the third group R3 since the maximum difference value of the third group R3 is 79. Then, the threshold value calculating unit 40 determines (e.g., calculates) the first threshold value of the first group R1 corresponding to 50 that is the maximum difference value selected from the first group R1, the first threshold value of the second group R2 corresponding to 103 that is the maximum difference value selected from the second group R2, and the first threshold value of the third group R3 corresponding to 79 that is the maximum difference value selected from the third group R3.

As a non-limiting example, the threshold value calculating unit 40 may multiply a ratio (for example, a predetermined ratio) A by the maximum difference values detected from the groups to calculate the first threshold values of the groups. A may be set to a value between 0 and 1. For instance, when A is set to 0.6, the first threshold value of the first group R1 is 30 (calculated by multiplying 0.6 by 50), the first threshold value of the second group R2 is 61.8 (calculated by multiplying 0.6 by 103), and the first threshold value of the third group R3 is 47.4 (calculated by multiplying 0.6 by 79). Thus, in this example, the first threshold values of the groups R1, R2, and R3 have different values.

The threshold value calculating unit 40 may be implemented, for example, in hardware or software (in conjunction with a computing processor, which may be shared with other components, such as the operating unit 20 or the group setting unit 30).

The touch determining unit 50 compares the first threshold value of a group with the difference values of the respective regions of the group to determine those regions having a larger difference value than the first threshold value of the group. The touch determining unit 50 determines these regions to be the touched regions.

When this touch determining technique is applied to the above-described example, the regions the belong to the first group R1 are compared with 30 (calculated to be the first threshold value of the first group R1) to determine which of the regions are touched, the regions that belong to the second group R2 are compared with 61.8 (calculated to be the first threshold value of the second group R2) to determine which of the regions are touched, and the regions that belong to the third group R3 are compared with 47.4 (calculated to be the first threshold value of the third group R3) to determine which of the regions are touched.

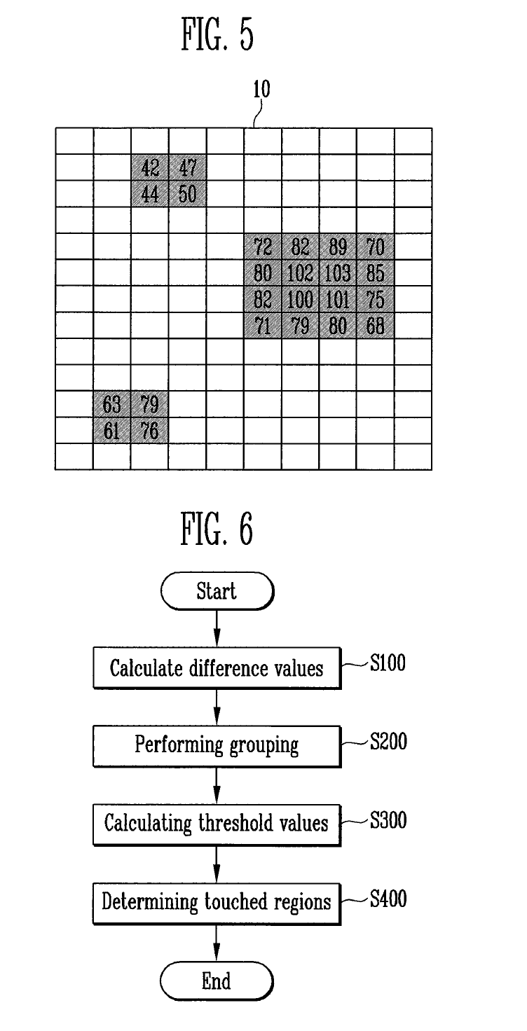

FIG. 5 is a view illustrating regions determined to be touched regions by the touch determining unit 50 according to an embodiment of the present invention.

Referring to FIG. 5, since the regions included in the first group R1 have the difference values 42, 44, 47, and 50 that are all larger than the first threshold value 30 of the first group R1, all of the regions included in the first group R1 are determined to be touched. In addition, the regions having the difference values 72, 82, 89, 70, 80, 102, 103, 85, 82, 100, 101, 75, 71, 79, 80, and 68 that are larger than the first threshold value 61.8 of the second group R2 among the regions included in the second group R2 are determined to be touched, while the regions having the difference values 40, 49, 58, 43, 50, 42, 45, 52, and 40 that are smaller than the first threshold value 61.8 are determined not to be touched. Likewise, the regions having the difference values 63, 79, 61, and 76 that are larger than the first threshold value 47.4 of the third group R3 among the regions included in the third group R3 are determined to be touched, while the regions having the difference values 40, 42, 41, 40, 40, and 41 that are smaller than the first threshold value 47.4 are determined not to be touched.

As illustrated in the above-described example, since the first threshold values corresponding to the maximum difference values of the groups R1, R2, and R3 are determined dynamically for each of the groups R1, R2, and R3, the correctness of the touch detection may be increased without losing a specific touch. The touch determining unit 50 may be implemented, for example, in hardware or software (in conjunction with a computing processor, which may be shared with other components, such as the operating unit 20, the group setting unit 30, or the threshold value calculating unit 40).

FIG. 6 is a flowchart illustrating a method of driving a touch sensing system according to an embodiment of the present invention.

Referring to FIG. 6, the method of driving the touch sensing system includes a step (S100) of determining (e.g., calculating) difference values, a step (S200) of performing grouping, a step (S300) of determining (e.g., calculating) first threshold values, and a step (S400) of determining touched regions. The steps may be carried out, for example, in hardware, in software (or firmware), or a combination thereof. To this extent, the steps may be carried out with the use of a processing unit (for example, a microprocessor) having a storage device (for example, a disk drive or solid state memory) and machine instructions configured to perform the steps when executed on the processing unit.

In the step (S100) of calculating the difference values, difference values between the sensing signals I output by the regions 11 of the touch sensing unit 10 and the baseline value are calculated. The step (S100) of calculating the difference values may be performed by the operating unit 20 included in the touch sensing system 1.

In the grouping step (S200), the regions in which the difference values exist among the plurality of regions 11 set by the touch sensing unit 10 are grouped into at least one group. The grouping step (S200) may be performed by the group setting unit 30 included in the touch sensing system 1. In the grouping step (S200), for example, adjacent regions among the regions in which the difference values exist are bound into the same group to generate at least one group.

In the threshold value calculating step (S300), the maximum difference values of the groups generated in the grouping step (S200) are determined and the first threshold values of the groups corresponding to the determined maximum difference values are calculated. The threshold value calculating step (S300) may be performed by the threshold value calculating unit 40 included in the touch sensing system 1. In addition, in the threshold value calculating step (S300), the ratio (for example, the predetermined ratio) A is multiplied by the maximum difference values detected by the groups to calculate the first threshold values of the groups. The ratio A may be set to a value between 0 and 1.

In the touch region determining step (S400), the regions whose difference value is larger than the first threshold value of their corresponding group are determined to be touched regions. The touch region determining step (S400) may be performed by the touch determining unit 50 included in the touch sensing system 1.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A touch sensing system for detecting at least one touch, the touch sensing system comprising:
a touch sensing unit comprising a plurality of touchable regions for outputting sensing signals of the at least one touch;
an operating unit for determining difference values between the sensing signals and a baseline value;
a group setting unit for grouping ones of the regions in which the difference values exist into one or more groups; and
a threshold value determining unit for determining maximum difference values from the groups to determine first threshold values of the groups corresponding to the determined maximum difference values.

2. The touch sensing system as claimed in claim 1, further comprising a touch determining unit for determining touched regions from the ones of the regions whose difference values are larger than their corresponding first threshold values.

3. The touch sensing system as claimed in claim 2, wherein the touched regions correspond to the at least one touch.

4. The touch sensing system as claimed in claim 1, wherein the group setting unit is configured to group adjacent regions from the ones of the regions into a same group.

5. The touch sensing system as claimed in claim 1, wherein the threshold value determining unit is configured to multiply a first ratio by the determined maximum difference values to calculate the first threshold values of the groups.

6. The touch sensing system as claimed in claim 5, wherein the first ratio is set to a value between 0 and 1.

7. The touch sensing system as claimed in claim 1, wherein the touch sensing unit comprises first sensor electrodes and second sensor electrodes that cross each other to implement a capacitance method of touch sensing.

8. The touch sensing system as claimed in claim 1, in which the difference values exist when they exceed a second threshold value.

9. The touch sensing system as claimed in claim 1, in which the difference values exist when they are not 0.

10. The touch sensing system as claimed in claim 1, wherein the touch sensing unit is a touch screen.

11. A method of driving a touch sensing system for detecting at least one touch, the method comprising:
outputting sensing signals of the at least one touch from a plurality of touchable regions of a touch sensing unit;
determining difference values between the sensing signals and a baseline value;
grouping ones of the regions in which the difference values exist into one or more groups; and
determining maximum difference values from the groups to determine first threshold values of the groups corresponding to the determined maximum difference values.

12. The method as claimed in claim 11, further comprising determining touched regions from the ones of the regions whose difference values are larger than their corresponding first threshold values.

13. The method as claimed in claim 12, wherein the touched regions correspond to the at least one touch.

14. The method as claimed in claim 11, wherein the grouping the ones of the regions comprises grouping adjacent regions from the ones of the regions into a same group.

15. The method as claimed in claim 11, wherein the determining the maximum difference values from the groups to determine the first threshold values of the groups corresponding to the determined maximum difference values comprises multiplying a first ratio by the determined maximum difference values to calculate the first threshold values of the groups.

16. The method as claimed in claim 15, wherein the first ratio is set to a value between 0 and 1.

17. The method as claimed in claim 11, wherein the touch sensing unit comprises first sensor electrodes and second sensor electrodes that cross each other to implement a capacitance method of touch sensing.

18. The method as claimed in claim 11, in which the difference values exist when they exceed a second threshold value.

19. The method as claimed in claim 11, in which the difference values exist when they are not 0.

20. The method as claimed in claim 11, wherein the touch sensing unit is a touch screen.
